(19) United States
(12) Patent Application Publication
(10) Pub. No.: US 2015/0066175 A1
(43) Pub. Date: Mar. 5, 2015

(54) AUDIO PROCESSING IN MULTIPLE LATENCY DOMAINS

(71) Applicant: AVID TECHNOLOGY, INC., Burlington, MA (US)

(72) Inventors: David M. Tremblay, Boulder, CO (US); Andrew Hall, San Francisco, CA (US)

(73) Assignee: AVID TECHNOLOGY, INC., Burlington, MA (US)

(21) Appl. No.: 14/013,539

(22) Filed: Aug. 29, 2013

(51) Int. Cl. G06F 3/16

(52) U.S. Cl. CPC G06F 3/165
USPC 700/94

(57) ABSTRACT

Methods and systems for generating computationally complex audio effects with low latency involve partitioning computation required to produce the effect into two components: a first component to be executed on a low latency signal network; and the second component to be executed simultaneously with the first component on a high latency signal network. For certain effects for which computation is separable into high and low latency functions, such dual signal network execution results in an overall signal latency of the low latency signal network and an overall efficiency of the high latency signal network. The low and high latency signal networks may be implemented on a DSP and a general purpose microprocessor respectively or both networks may be implemented on a single CPU. Simultaneous dual network implementation is especially beneficial in professional audio performance and recording environments.

### BACKGROUND

Many commonly used audio processing effects, such as convolution reverbs, pitch correction, and noise reduction are often implemented by loading a large block of data into a buffer of a processor and then processing the block in parallel. Such an approach is generally driven by the need to make any fast Fourier transform (FFT) algorithms involved as computationally efficient as possible. However, larger block sizes have the effect of increasing signal network latency, which is undesirable in most real-time audio environments.

In attempting to maintain low latency, designers have used multiple smaller buffers until enough audio data has accumulated for processing. Once sufficient data has accumulated, the data is processed in a real-time thread. This can cause very large spikes in processing requirements that may cause instability in an audio signal network.

In one approach to addressing this problem, a background (idle) thread is used to process the data. However, it is not guaranteed that the idle thread will have enough time to process the data before it is needed, with the result that this approach may also cause instability in the audio signal network. In another technique, a high priority thread is created to process the data. While this thread is more likely to process the needed data in time, it can cause resource contention with the host's real time threads and also cause instability. Such approaches are also complex to implement. In another approach, additional real-time processing hardware is added to reduce latency by splitting the computation between multiple signal processors. This can introduce programming complexity, and drive up system cost.

A low cost, practical solution that is able to process audio effects with low latency without risking instability is needed.

### SUMMARY

In general, the methods, systems, and computer program products described herein employ two different latency signal networks simultaneously to process audio effects, thus benefitting from the low latency of the low latency signal network and the computational power and efficiency of a high latency network.

In general, in one aspect, an audio processing method includes: receiving an audio signal; partitioning computation required to generate an audio effect on the audio signal into a low latency component and a high latency component; executing the low latency component on a low latency signal network; executing the high latency component on a high latency signal network; and wherein the audio effect is generated with an overall efficiency characterized by the high latency signal network and an overall latency characterized by the low latency signal network.

Various embodiments include one or more of the following features. The audio effect is generated using a plug-in module in data communication with a digital audio workstation. A buffer size of the high latency signal network is greater than a buffer size of the low latency signal network. A buffer size of the high latency signal network is between about 512 bytes and about 2048 bytes, and a buffer size of the low latency network is between about 1 and 64 bytes. The low latency signal network and the high latency signal network are implemented as a high priority thread and a low priority thread respectively on a single host CPU. The low latency signal network is implemented on a DSP and the high latency signal network is implemented a general purpose CPU. The audio effect is generated with a latency of less than about 7 milliseconds. The audio effect is a reverb and the low latency component includes computation of early reflections and the high latency component includes computation of a tail of the reverb. The audio effect is a pitch correction effect and wherein the high latency component includes analysis of the audio signal to identify portions of the audio signal requiring pitch shifting, and the low latency component includes implementation of pitch shifting based on results of the analysis. The audio effect is a spectrum analyzer and wherein the high latency component includes FFT analysis of the audio signal. The audio effect is a noise reduction effect and the high latency component includes an FFT-based algorithm to separate the signal components from the noise components. Executing the low latency component and executing the high latency component are performed sequentially. Executing the low latency component and executing the high latency component are performed in parallel.

In general, in another aspect, a computer program product includes: a computer-readable storage medium with computer program instructions encoded thereon, wherein the computer program instructions, when processed by a computer, instruct the computer to perform a method for generating an audio effect, the method comprising: receiving an audio signal; partitioning computation required to generate an audio effect on the audio signal into a low latency component and a high latency component; executing the low latency component on a low latency signal network; executing the high latency component on a high latency signal network; and wherein the audio effect is generated with an overall efficiency characterized by the high latency signal network and an overall latency characterized by the low latency signal network.

In general, in a further aspect, a system for generating an audio effect includes: a memory for storing computer-readable instructions; and a processor connected to the memory, wherein the processor, when executing the computer-readable instructions, causes the system to perform a method for generating the audio effect, the method comprising: receiving an audio signal; partitioning computation required to generate an audio effect on the audio signal into a low latency component and a high latency component; executing the low latency component on a low latency signal network; executing the high latency component on a high latency signal network; and wherein the audio effect is generated with an overall efficiency characterized by the high latency signal network and an overall latency characterized by the low latency signal network.

### BRIEF DESCRIPTION OF THE DRAWINGS

FIG. 1 is a high level flow diagram showing the simultaneous use of a low latency signal network and a high latency signal network.

FIG. 2 is a high level block diagram of a system that includes a dual signal network system for processing audio effects.

FIG. 3 is a high level flow diagram showing the use of a low latency signal network and a high latency signal network for implementing a reverb effect.

### DETAILED DESCRIPTION

In a professional audio environment, it is important to be able to process audio with low latency, especially in live performance and recording environments. For most applications, a latency of 7 milliseconds or lower is acceptable, although for certain high-end settings, an upper latency limit of 3 milliseconds is desired. Such latencies place significant constraints on the performance of the hardware on which audio signal networks are implemented. These requirements are especially challenging because the processing of many popular audio effects is computationally intensive. Furthermore, as mentioned above, the processing algorithms often involve FFTs, for which processing efficiency is greatly enhanced when data is accumulated and processed as a large block, thereby exploiting the parallel processing architectures of modern CPUs. But the larger the size of the buffer that needs to be filled with audio data before it is processed, the greater the resulting latency. Thus, while a block size of 1024 samples or above enables a suitable CPU to process audio data efficiently, the associated throughput latency is about 70 milliseconds, which is unacceptably high. In order to achieve throughput latencies of 7 milliseconds, the block size is limited to about 128 samples, for which audio effect processing efficiency of most CPUs is greatly reduced. The block size not only affects efficiency, but also, in a FFT calculation, determines frequency resolution, with larger block sizes delivering higher frequency resolution results.

As used herein, the term audio effect refers to effects that alter the sound of an audio signal, such as reverb, pitch shifting, and noise reduction, as well as audio processes that analyze and display information from audio signals, such as a spectral analyzer, without changing the audio signal itself.

In the methods and systems described herein, two audio signal networks are provided—a low latency network and a high latency network. As used herein, the terms “low/high latency signal network” are often referred to as a “low/high latency domain,” and the terms are considered to be synonymous. A framework is provided for a computational module (also referred to as a plug-in) to deploy both networks simultaneously, thus having their algorithms execute in two different latency domains. This enables audio effect plug-in developers to partition their algorithms into a low latency portion and a high latency portion. While the signal that is processed in the high latency network is subject to a correspondingly high delay, the delay can be made constant, and factored in to the programming of each particular plug-in.

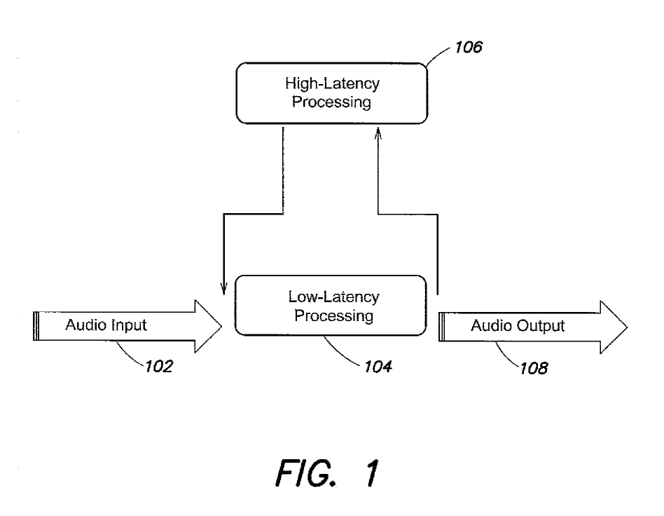

For example, a low latency audio processing kernel may be used to preprocess incoming data. After preprocessing, the data may be sent to a high latency domain for processing of the high latency algorithm component of an effect. This scheme is illustrated in FIG. 1. Audio input 102 is routed to low latency signal network 104 that performs functions that are allocated to it. The low latency network output is then routed to high latency network 106 via standard audio outputs. After performing the high latency functions on the high latency network, the processed data is output back to the low latency signal network, where it may combined with the audio input in a manner appropriate to the effect being generated. The resulting audio output is then provided to the host digital audio workstation or other device or system. As used herein, a digital audio workstation (DAW) comprises a system hosting a non-linear digital audio editing application that includes recording and playback functionality as well as local storage. Optionally, the DAW user interface displays a timeline representation of a musical composition being edited. PRO TOOLS®, a product of Avid Technology, Inc., of Burlington, Mass. is an example of a commercially available digital audio workstation that includes such functionality.

Alternative pathways may be used, such as sending audio input 102 to high latency network 106 before processing by low latency network 104, and routing the output of the high latency network back to the input of the low latency network. In another signal path, the audio input is routed to the high latency network after processing by the low latency network (as in the case illustrated in FIG. 1), and then output directly from there. This pathway might be used in the analysis use case (discussed below), with the output routed directly to the audio output, without passing through the low latency network again.

Low latency and high latency components may be executed sequentially. However, since the block size associated with the low latency signal network is low, it is able to fill and process multiple blocks during the time that a high latency block is filled and then completes its processing. Thus the computation of the high latency component may overlap several low latency computation cycles, i.e., take place in parallel with the low latency computation.

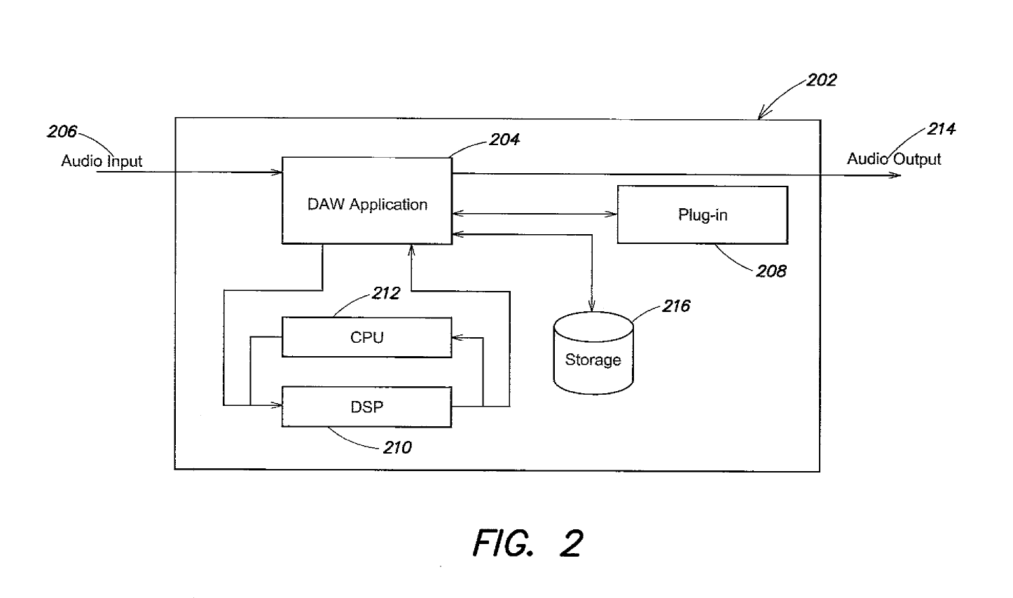

In a typical hardware implementation, illustrated in FIG. 2, system 202, which may be a workstation, laptop, mobile device, or other computing platform including cloud-based platforms, hosts DAW application 204 (i.e., a software application that implements DAW functionality on the host) and receives audio input 206. Plug-in 208, a software module for generating one or more audio effects, is in data communication with DAW application 204. The plug-in software directs the audio processing to be split between a low latency signal network implemented on DSP 210, and a high latency signal network implemented on CPU 212. After processing to generate the effect, the resulting audio may be output from the host 214, or stored on local storage 216.

DSPs usually have low buffer sizes that can store between 1 and 64 samples, with 16, 32, or 64 sample capacities being the most common. With their smaller buffer sizes, DSPs are optimized for low latency, but generally have less processing power than general purpose microprocessors. In addition, their small buffer size limits the processing functions for which their special purpose hardware can be most efficient to those that do not require large amounts of memory during processing. By contrast, general purpose CPUs enable the use of larger buffer sizes ranging up to 1024-4096 samples, which introduces a large (but fixed) latency on the one hand, but high processing throughput on the other, enabling the processing to keep up with real time, albeit with a fixed delay. CPUs are also able to process low latency functions that do not require fully loaded buffers. Thus two signal networks may be implemented in a single CPU, with the low latency network being assigned a higher thread priority than the high latency network. By keeping much of the processing out of the low latency thread, the risk of overrunning the allotted processing time for the small buffer is reduced. In most dual signal network audio effect implementations, the majority of the computation is performed by the high latency network with the remainder being performed by the low latency network.

Advantages of simultaneously using dual signal networks may also be seen by comparing this method with an implementation that uses real-time and multi-threaded operating system (OS) technology. In a complex environment, such as that associated with a DAW application, a large number of threads are spawned, each requiring careful tuning This renders it impractical and/or undesirable to generate low latency effects using a thread scheduler, preemption, IPC mechanisms, and managing priorities within such an environment. Although it may be possible to obtain the end result achieved by the simultaneous use of dual networks using OS mechanisms, it is challenging and risky.

We now describe examples of audio processing effects that lend themselves to dual latency network processing. They may be implemented in the form of a software plug-in, as in the case illustrated in FIG. 2. In general, suitable audio effects are those that involve algorithms that are well suited to block-based processing. In many cases such effects are complex, and the computation involves FFTs or wavelets.

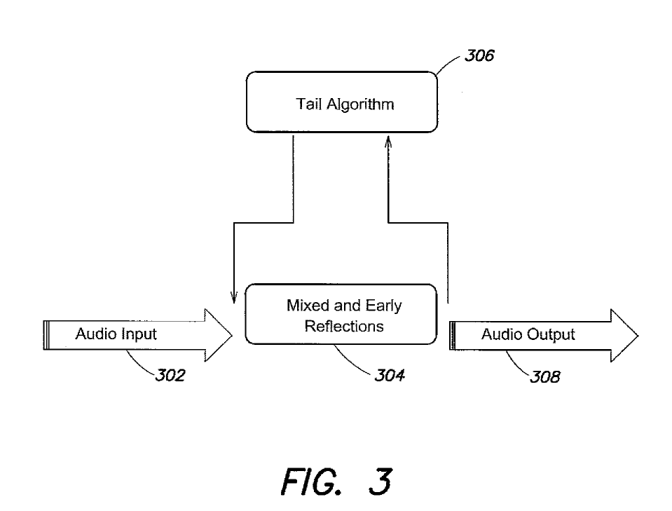

FIG. 3 illustrates the application of dual latency network processing to the generation of the reverb effect. Audio input 302 is routed to low latency signal network 304, which performs the processing for early reflections. To generate the early reflections, a few short delays are computed, which does not require much processing, and can be performed even with the small buffer size of the low latency network and a consequent lower efficiency algorithm, thus enabling low latency. The aim is to perform only as much processing as is strictly required in the latency network. To compute the longer delay tail in the reverb, the output is routed to high latency network 306, which performs large memory tap delay lines or convolutions. The processed output is routed back to low latency domain 304 for mixing of the tail reflections from earlier audio with the current low latency early reflections and then output (308). With the compute-intensive parts of the computation moved to the CPU, the DSP is easily able to process the early reflections with low latency. By contrast, when using prior methods to achieve acceptable latency, a choice had to be made between using multiple DSP chips (e.g., up to six), with increased system cost and difficulty of programming on the one hand, and using the CPU in an inefficient manner at lower buffer sizes on the other. Furthermore, embedded DSPs lack sufficient processing power to generate full surround reverb effects, regardless of the buffer size.

Pitch correction is a further example for which the processing may benefit from the dual latency domain approach. The pitch correction algorithms use an FFT for an analysis phase in which the amount of any required pitch correction is computed. This is faster and easier to implement on the high latency domain of a CPU. The low latency domain then uses the “pitch events,” i.e., the portions of the signal requiring correction, determined by analysis phases to perform the actual pitch shifting operation, which may not be FFT-based.

To implement a noise reduction effect, the noise reduction algorithms use FFTs and take advantage of the high block size on the high latency domain. In this case, the entire signal loops through the high latency, incurring its associated high latency, but benefitting from the efficiency associated with high block size. This has the effect of eliminating the spiky performance that would result from using the low latency network.

In implementing a spectral analyzer function, a high number of samples, e.g., 1024, are loaded into the high latency domain buffer before performing an FFT. The FFT is performed when the 1024-sample buffer is full. The time taken to fill this buffer depends on the sampling rate, the number of samples in a read/write buffer, and the number of read/write buffers. The resultant delay is approximately 20 milliseconds, but the processing happens at predictable, regular intervals, which facilitates the scheduling of the various threads on the processor. A delay of about 20 milliseconds is acceptable since the output of the analyzer function is typically displayed using graphics that only refreshes at a rate of 30-60 Hz. The low latency domain simply passes the audio through in this case, but a significant benefit of the simultaneous dual domain approach is the smoothing out of the processing load on the host CPU as compared to the prior methods. In prior DSP-based analyzer implementations, the required number of samples for performing the FFT greatly exceeds the DSPs low latency buffer capacity. For example, if a 1024-point FFT is being performed, and the low latency buffer size is 64 samples, then 16 buffer loads need to be loaded and stored before an FFT operation can be performed. In order to complete the FFT processing before the subsequent (i.e., 17^{th}) buffer is full and provide the results with minimum latency, the FFT operation must be completed within the time it takes to fill the buffer. For a 48 kHz sampling rate, the corresponding time is 1.3 milliseconds. This results in a performance spike after accumulation of each set of 16 buffers. By moving the FFT operation to the high latency signal network, not only is there no need to accumulate multiple buffers of audio samples, but since it takes about 20 milliseconds to accumulate a full 1024 sample block, the processor has more time to complete the operation. Furthermore, the operation is being performed every time the buffer is full with incoming samples (not every 16^{th} time), thus smoothing out the performance of the high latency signal network.

The various components of the system described herein may be implemented as a computer program using a general-purpose computer system. Such a computer system typically includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

One or more output devices may be connected to the computer system. Example output devices include, but are not limited to, liquid crystal displays (LCD), plasma displays, various stereoscopic displays including displays requiring viewer glasses and glasses-free displays, cathode ray tubes, video projection systems and other video output devices, printers, devices for communicating over a low or high bandwidth network, including network interface devices, cable modems, and storage devices such as disk or tape. One or more input devices may be connected to the computer system. Example input devices include, but are not limited to, a keyboard, keypad, track ball, mouse, pen and tablet, touchscreen, camera, communication device, and data input devices. The invention is not limited to the particular input or output devices used in combination with the computer system or to those described herein.

The computer system may be a general purpose computer system, which is programmable using a computer programming language, a scripting language or even assembly language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services. The computer system may be connected to a local network and/or to a wide area network, such as the Internet. The connected network may transfer to and from the computer system program instructions for execution on the computer, media data such as video data, still image data, or audio data, metadata, review and approval information for a media composition, media annotations, and other data.

A memory system typically includes a computer readable medium. The medium may be volatile or nonvolatile, writeable or nonwriteable, and/or rewriteable or not rewriteable. A memory system typically stores data in binary form. Such data may define an application program to be executed by the microprocessor, or information stored on the disk to be processed by the application program. The invention is not limited to a particular memory system. Time-based media may be stored on and input from magnetic, optical, or solid state drives, which may include an array of local or network attached disks.

A system such as described herein may be implemented in software, hardware, firmware, or a combination of the three. The various elements of the system, either individually or in combination may be implemented as one or more computer program products in which computer program instructions are stored on a computer readable medium for execution by a computer, or transferred to a computer system via a connected local area or wide area network. Various steps of a process may be performed by a computer executing such computer program instructions. The computer system may be a multiprocessor computer system or may include multiple computers connected over a computer network. The components described herein may be separate modules of a computer program, or may be separate computer programs, which may be operable on separate computers. The data produced by these components may be stored in a memory system or transmitted between computer systems by means of various communication media such as carrier signals.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. An audio processing method comprising:
receiving an audio signal;
partitioning computation required to generate an audio effect on the audio signal into a low latency component and a high latency component;
executing the low latency component on a low latency signal network;
executing the high latency component on a high latency signal network; and
wherein the audio effect is generated with an overall efficiency characterized by the high latency signal network and an overall latency characterized by the low latency signal network.

2. The method of claim 1, wherein the audio effect is generated using a plug-in module in data communication with a digital audio workstation.

3. The method of claim 1, wherein a buffer size of the high latency signal network is greater than a buffer size of the low latency signal network.

4. The method of claim 1, wherein a buffer size of the high latency signal network is between about 512 bytes and about 2048 bytes, and a buffer size of the low latency network is between about 1 and 64 bytes.

5. The method of claim 1, wherein the low latency signal network and the high latency signal network are implemented as a high priority thread and a low priority thread respectively on a single host CPU.

6. The method of claim 1, wherein the low latency signal network is implemented on a DSP and the high latency signal network is implemented a general purpose CPU.

7. The method of claim 1, wherein the audio effect is generated with a latency of less than about 7 milliseconds.

8. The method of claim 1, wherein the audio effect is a reverb and wherein the low latency component includes computation of early reflections and the high latency component includes computation of a tail of the reverb.

9. The method of claim 1, wherein the audio effect is a pitch correction effect and wherein the high latency component includes analysis of the audio signal to identify portions of the audio signal requiring pitch shifting, and the low latency component includes implementation of pitch shifting based on results of the analysis.

10. The method of claim 1, wherein the audio effect is a spectrum analyzer and wherein the high latency component includes FFT analysis of the audio signal.

11. The method of claim 1, wherein the audio effect is a noise reduction effect and the high latency component includes an FFT-based algorithm to separate the signal components from the noise components.

12. The method of claim 1, wherein executing the low latency component and executing the high latency component are performed sequentially.

13. The method of claim 1, wherein executing the low latency component and executing the high latency component are performed in parallel.

14. A computer program product comprising:
a computer-readable storage medium with computer program instructions encoded thereon, wherein the computer program instructions, when processed by a computer, instruct the computer to perform a method for generating an audio effect, the method comprising:
receiving an audio signal;
partitioning computation required to generate an audio effect on the audio signal into a low latency component and a high latency component;
executing the low latency component on a low latency signal network;
executing the high latency component on a high latency signal network; and
wherein the audio effect is generated with an overall efficiency characterized by the high latency signal network and an overall latency characterized by the low latency signal network.

15. A system for generating an audio effect, the system comprising:
a memory for storing computer-readable instructions; and
a processor connected to the memory, wherein the processor, when executing the computer-readable instructions, causes the system to perform a method for generating the audio effect, the method comprising:
receiving an audio signal;
partitioning computation required to generate an audio effect on the audio signal into a low latency component and a high latency component;
executing the low latency component on a low latency signal network;
executing the high latency component on a high latency signal network; and
wherein the audio effect is generated with an overall efficiency characterized by the high latency signal network and an overall latency characterized by the low latency signal network.
